(19) United States
(12) Patent Application Publication
(10) Pub. No.: US 2017/0023939 A1
(43) Pub. Date: Jan. 26, 2017

(54) System and Method for Controlling an Unmanned Aerial Vehicle over a Cellular Network

(71) Applicants: Joel David Krouse, Friendswood, TX (US); Matthew J. Leonard, College Station, TX (US)

(72) Inventors: Joel David Krouse, Friendswood, TX (US); Matthew J. Leonard, College Station, TX (US)

(21) Appl. No.: 15/149,075

(22) Filed: May 6, 2016

Related U.S. Application Data
(60) Provisional application No. 62/157,869, filed on May 6, 2015.

(51) Int. Cl. G05D 1/00; G08G 5/00; G05D 1/10; G08G 5/04; B64C 39/02; B64D 47/08

(52) U.S. Cl. CPC G05D 1/0022; B64C 39/024; B64D 47/08; G05D 1/104; G08G 5/045; G08G 5/0069; H04L 65/4069

(57) ABSTRACT

A system and method of operating a system for controlling an unmanned aerial vehicle over a cellular network provides capability for UAV operators to control the UAV without requiring the operator to be within a limited range of the UAV, enabling non-line-of-sight control. A command and control station is communicatively coupled to the cellular network, which is in turn communicatively coupled to the UAV. Video streaming capability is provided, in addition to a modular circuitry unit capable of accepting a wide variety of customizable circuitry units designed for various specific purposes and capabilities.

The current application claims a priority to the U.S. Provisional Patent application Ser. No. 62/157,869 filed on May 6, 2015.

### FIELD OF THE INVENTION

The present invention relates generally to unmanned aerial vehicles (UAVs). More particularly, the present invention relates to controlling UAVs over a cellular network.

### BACKGROUND OF THE INVENTION

Unmanned aerial vehicles are also known as drones, unpiloted aerial vehicles, unmanned aerial systems (UAS) and a remotely piloted aircraft (RPA). Command and control features govern how UAVs respond to inputs from internal stimulus or in many cases the remote pilot. Essentially, the vehicles are an aircraft commanded and controlled without a human pilot aboard. There are two classifications of unmanned vehicles: autonomous aircraft and remotely piloted aircraft. Unmanned aerial vehicles have started to be rebranded from drones to unmanned aerial systems in order to disassociate from the military uses of the vehicles. The unmanned aerial systems have become popular because of the multitude of functions. Some examples include, aerial surveying of crops, acrobatic aerial footage in filmmaking, search and rescue operations, inspecting power lines and pipelines, counting wildlife, and delivering medical supplies to remove or otherwise inaccessible regions. In addition, communications via cell phones have also become increasingly accessible and powerful. Specifically, the cell phone towers providing the signal to the phones are now established and functional. Combining both command and control of unmanned aerial vehicles with communications using a cell phone signal has become a developing technology to create non-line-of-sight or commonly referred to as over-the-horizon functionality.

It is therefore an objective of the present invention to outfit an unmanned aerial vehicle with access to a cellular network, particularly a 4G LTE network for communication, command and control. The law enforcement telecommunications department shows interest in such a device to be used in surveillance and or a law enforcement context. The device is specifically designed to fit the desired capabilities set by law enforcement. The device provides modularity, interoperability, and provides plug and play capability in order to increase functionality and ease of use. The system utilizes C2+ Technology, which includes the modular integrated stackable layer and public integrated network key infrastructure.

### BRIEF DESCRIPTION OF THE DRAWINGS

FIG. 1 is a general diagram showing the communication between the command and control station through the cellular network to the UAV.

FIG. 2 is an illustrative diagram showing general capabilities of the present invention.

FIG. 3 is a component diagram of the UAV.

FIG. 4 is a diagram showing the functions of the modular integrated stackable layer (MISL).

FIG. 5 is a stepwise flow diagram describing the general method of the present invention.

FIG. 6 is a stepwise flow diagram showing steps for executing operational algorithms of circuitry components of the modular circuitry unit.

FIG. 7 is a stepwise flow diagram showing steps for activating the navigation system of the UAV.

FIG. 8 is a stepwise flow diagram showing steps for hazard mitigation and obstacle avoidance.

FIG. 9 is a stepwise flow diagram showing steps for forming a group flight formation with multiple UAVs.

FIG. 10 is a general electronics and communication diagram.

FIG. 11 is a diagram showing the connections for the public integrated network key infrastructure (PINKI).

FIG. 12 is a diagram showing the types of sensor accommodations necessary to provide protection to the UAV.

FIG. 13 is a diagram showing the basic functional components of one exemplary embodiment of the UAV.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

In view of the aforementioned problem(s), the present invention is a subset of, or outfitting of, an unmanned aerial vehicle, which establishes a communication link between the vehicle and control station (providing command and control capability) through the use of a 4G long-term evolution (LTE) network, which utilizes secure communications. The device has video logging capability and can output imagery to the control station. In addition, there can be multiple UAVs that can fly in formation to provide a swarm capability. The system has a plug-and-play capability by means of a modular integrated stackable layer (MISL). Before explaining at least one embodiment of the present invention in detail, it is to be understood that the invention is not limited in its application to the details of the components and arrangements as described or illustrated, nor limited to a particular UAV platform. The UAV may be a rotary of fixed-wing, or another type of UAV. The invention is capable of other embodiments and of being utilized and carried out in various ways. It is also to be understood that the phrasing and terminology employed herein are for the purpose of description and should not be regarded as limiting. As such, the present invention is primarily used for the purpose of outfitting unmanned aerial vehicles, but the device may be applied to many other embodiments, vehicle platforms, settings, situations, and scenarios.

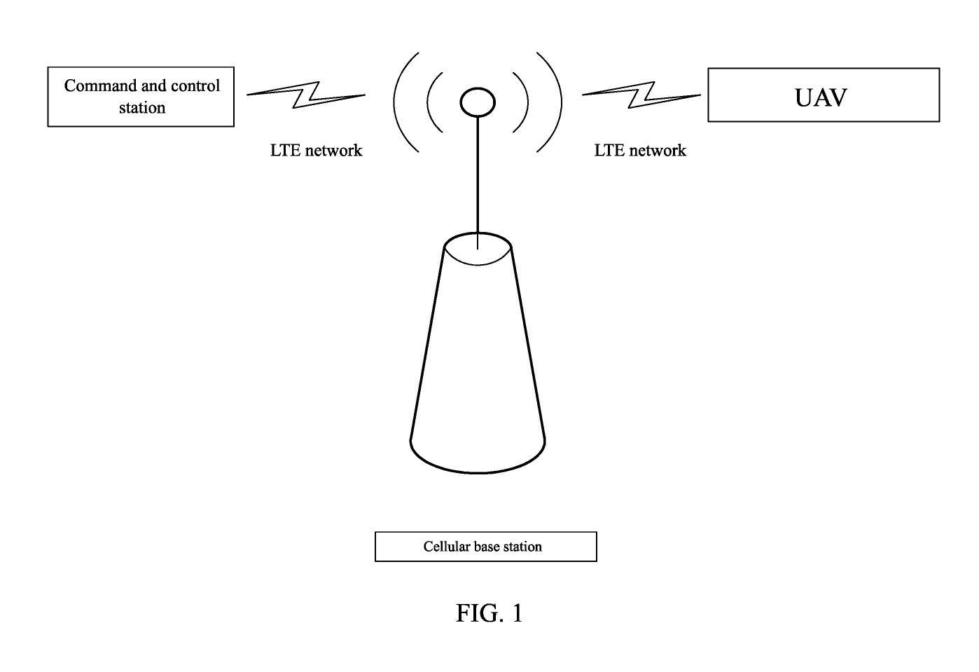

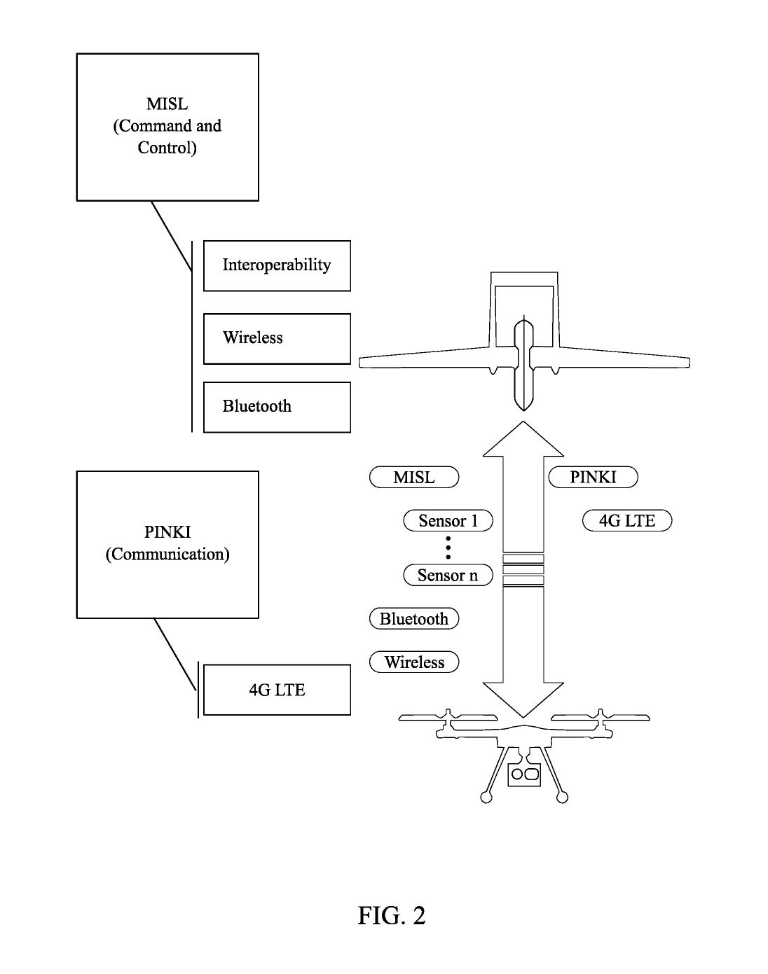

Referring to FIG. 1-2, the general system of the present invention comprises a UAV, a cellular network, and a command and control (CAS) station. As discussed, the UAV may be any type of UAV, fixed wing, rotary, or otherwise, which facilitates the spirit and functionality of the present invention described herein. The cellular network may be any applicable cellular network, but cellular network is preferably a 4G LTE network for reliability and connection speed. The CAS station may be any physical device, apparatus, computing device, user interface, or other device or combination of devices which facilitates user input for command and control of the UAV.

The CAS station is communicatively linked to the UAV over the cellular network. This communication link may be achieved in a variety of ways, using any electronic, digital, analog, radio or other means, passing through any number and configuration of internet nodes, communication relays, cell towers, cellular base stations, or other waypoints in order to facilitate electronic communication between the CAS station and the UAV through the cellular network.

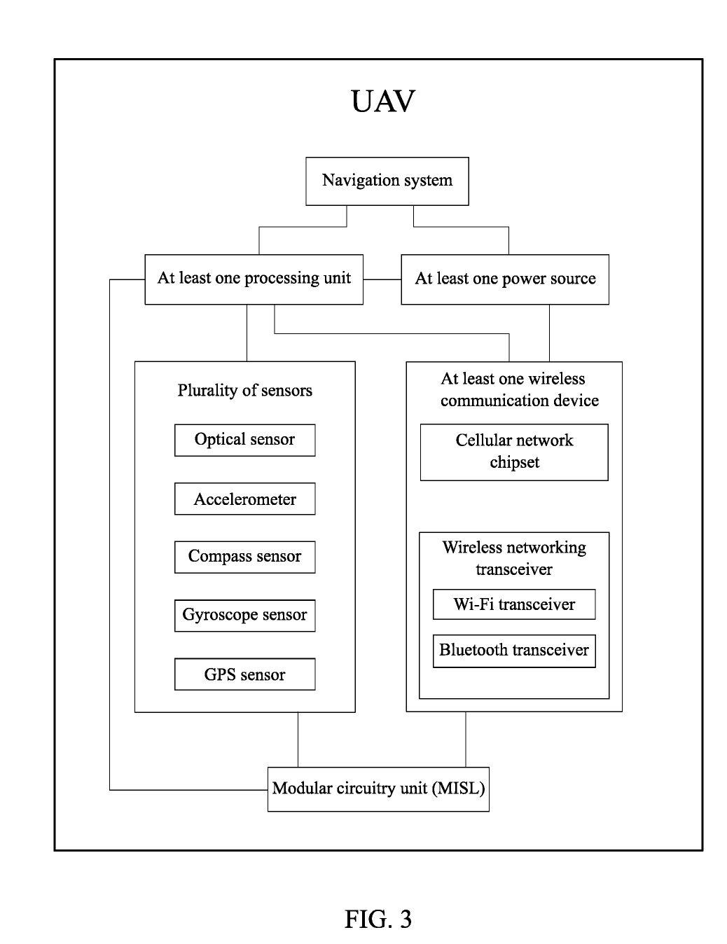

Referring to FIG. 3, in one embodiment, the UAV comprises a navigation system, at least one processing unit, a plurality of sensors, at least one wireless communication device, and at least one power source. The CAC station is communicatively coupled with at least one of the at least one processing units through the cellular network.

The navigation system may be any combination of physical flight controls such as motors, rotors, stabilizers, rudders, spoilers, flaps, tabs, ailerons, and other flight control mechanisms, mechanical, hydro-mechanical, electro-mechanical, pneumatic or otherwise. The navigation system may also comprise any electrical circuitry, electronics, circuit boards, relays, programming logic, and other electrical or electronic components necessary to facilitate flight control of the UAV.

The plurality of sensors comprises any sensors that facilitate the spirit and purpose of the present invention, in particular sensors that are required for operation of the UAV and other sensors suited to various purposes and applications for UAV deployment. Preferably, the plurality of sensors comprises an optical sensor, an accelerometer, a compass sensor, a gyroscope sensor, and a global positioning system (GPS) sensor. The accelerometer, the compass sensor, the gyroscope sensor, and the GPS sensor may also be considered to be navigation sensors. In one embodiment, the optical sensor is a high-definition camera, or another type of camera. In one embodiment, the optical sensor is a thermal imaging sensor. Preferably, the optical sensor is mounted to a gimbal in order to achieve a wide and adjustable field of vision. The gimbal is electronically connected to the at least one processing unit, wherein the processing unit controls the orientation of the gimbal. In various embodiments, the plurality of sensors may further comprise radar, sonar, light detection and ranging (LIDAR), FLIR, a rangefinder, gas detection sensors, temperature sensors, proximity sensors, or any other type of sensor.

In one embodiment, the at least one processing unit is a single processing unit which handles all necessary programming logic, calculations, and other electronic inputs and outputs. In another embodiment, the at least one processing unit may comprise two or more processing units which are tasked with different duties, such as communicating with the cellular network and handling the sensor inputs. At least one of the processing units is communicatively coupled to the cellular network through one of the wireless communication devices.

The at least one wireless communication device comprises any type of desired wireless communication device. In all embodiments, the at least one wireless communication device comprises a cellular network chipset, through which at least one of the at least one processing unit is communicatively coupled to the cellular network. More specifically, in the preferred embodiment of the present invention the cellular network chipset is a 4G LTE chipset, though in various alternate embodiments various other cellular network chipsets may be utilized, such as, but not limited to, a 3G chipset.

In one embodiment, the at least one wireless communication device comprises a wireless networking transceiver complying with the Institute of Electrical and Electronics Engineers (IEEE) 802.11 wireless local area network (WLAN) standards. In one embodiment, the wireless networking transceiver is a Wi-Fi transceiver. In one embodiment, the wireless networking transceiver is a Bluetooth transceiver. In various embodiments, the at least one wireless communication device comprises the aforementioned cellular network chipset in any combination alongside either the Wi-Fi transceiver, the Bluetooth transceiver, or both.

In most embodiments, each of the at least one power source is a battery. In one embodiment, the at least power source comprises a single battery. In another embodiment, the at least power source comprises two or more batteries that power different components and/or provide different power levels to different components. Each battery of the at least one power source may be of any preferred battery type, such as, but not limited to, lithium-ion, nickel-cadmium, alkaline, nickel-zinc, or any other type of battery. It is contemplated that other technologies may also be utilized at the at least one power source, so long as they are capable of providing sufficient electrical power to the various components of the present invention. In other embodiments, alternate power sources such as a liquid fueled power source may be comprised as the at least one power source.

As previously mentioned, a single processing unit may be utilized to control all electronic aspects of the UAV, or multiple processing units may be split among the various tasks and components of the UAV. At least one of the processing units is electronically connected to the plurality of sensors, and at least one of the processing units is electronically connected to each wireless communication device. At least one of the processing units is electronically connected to the navigation system. Similarly, at least one of the power sources is electrically connected to at least one of the processing units, and at least one of the power sources is electrically connected to the navigation system. If applicable, at least one of the power sources may be electrically connected to one or more of the plurality of sensors and to one or more of the wireless communication devices.

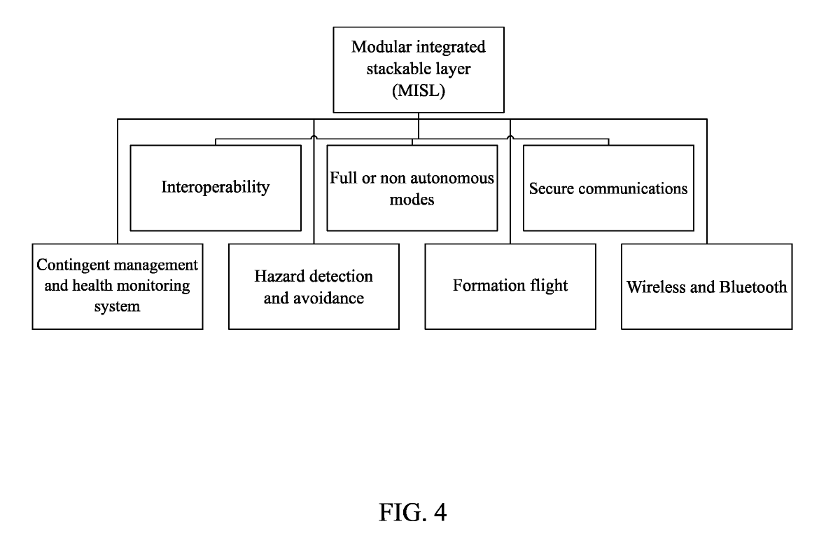

One notable aspect of the present invention is the use of a modular circuitry unit. The modular circuitry unit is electronically connected to each of the at least one processing unit, each of the plurality of sensors, and each wireless communication device. The modular circuitry unit provides the capability to easily connect and remove various circuit boards geared towards a wide variety of applications, such as, but not limited to, processing units such as microcontrollers, sensor packages, communications, signal conditioning circuitry, and other specialized circuitry designed for a specific purpose. In one embodiment, each of the at least one processing unit, each of the wireless communication devices, and each of the plurality of sensors is thus integrated within the modular circuitry unit. Referring to FIG. 4, in the preferred embodiment of the present invention, the modular circuitry unit is known piece of technology known as a modular integrated stackable layer, or MISL, which is configured for customization and combination of printed circuit boards. The MISL architecture encompasses a series of layers of printed circuit board that can be quickly stacked into a small form factor footprint that provides a wide range of technologies. An application-specific configuration can be quickly and easily contrived through the modular, plug and play nature of the MISL. In some embodiments of the present invention, each processing unit, the plurality of sensors, each wireless communication device, and each power source is hermetically sealed for protection. Hermetic sealing of the aforementioned components is not a necessity, however.

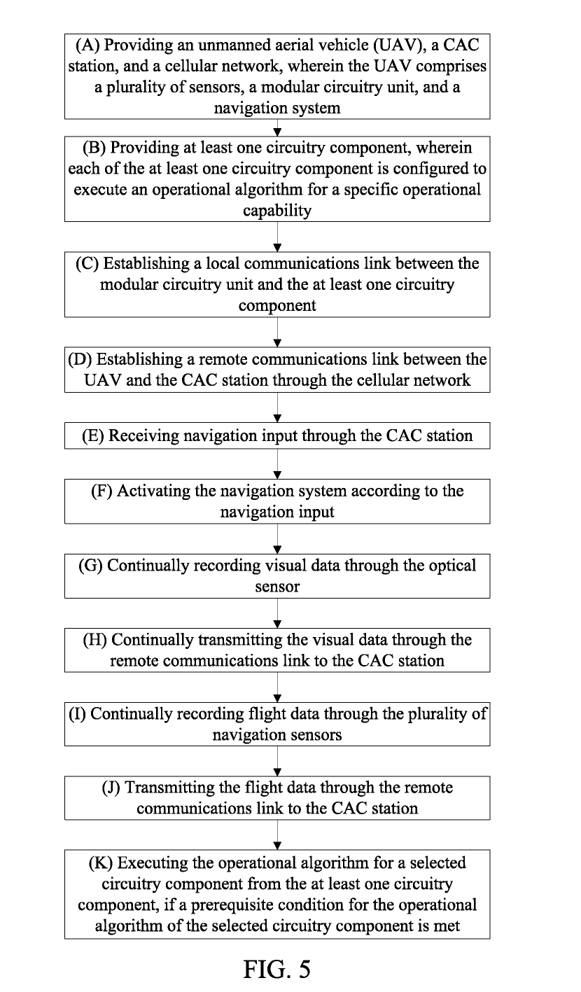

Referring to FIG. 5, in the general method of the present invention, the aforementioned UAV, CAC station, and cellular network are provided. Additionally provided is at least one circuitry component, wherein each of the at least one circuitry component is configured to execute an operational algorithm for a specific operational capability. The at least one circuitry component is a printed circuit board that may be installed onto the aforementioned MISL. A local communications link is established between the modular circuitry unit and the at least one circuitry component. This is done by connecting the circuitry component to the MISL, and performing any configuration operations between the circuitry component and the MISL, if necessary.

A remote communications link is also established between the UAV and the CAC station through the cellular network. Navigation input is received through the CAC station, and the navigation system of the UAV is activated according to the navigation input. Visual data is continually recorded through the optical sensor, and the visual data is continually transmitted through the communications link to the CAC station. Flight data is also continually recorded through the plurality of navigation sensors, and the flight data is also continually transmitted to the CAC station through the remote communications link. The remote communications link between the UAV and the CAC station is encrypted for security.

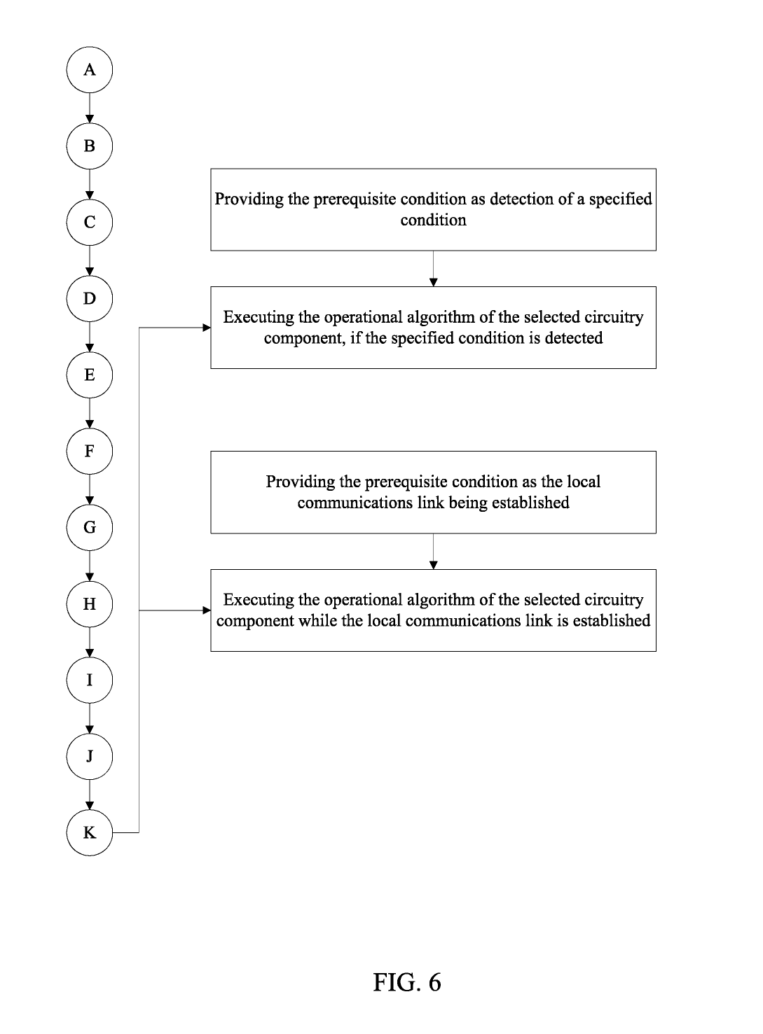

Referring to FIG. 6, the operation algorithm for a selected circuitry component from the at least one circuitry component is executed, if a prerequisite condition for the operational algorithm of the selected circuitry component is met. Various circuitry components of the MISL may have different prerequisite conditions. In one embodiment, a condition must be detected in order for the operational algorithm to be executed; for example, a hazard must be detected in order for an operational algorithm of hazard mitigation to be executed. Thus, in one embodiment the prerequisite condition is provided as detection of a specified condition, and the operational algorithm of the selected circuitry component is executed if the specified condition is detected. In another embodiment, the operational algorithm is constantly being executed, such as environmental scanning and mapping, and thus the only prerequisite is that the UAV and the specified circuitry component are operational and running. Thus, in one embodiment the prerequisite condition is provided as the local communications link being established between the modular circuitry unit and the selected circuitry component. While the local communications link is established, the operational algorithm of the selected circuitry component is executed. It should be noted that other prerequisites may be similarly defined in order to achieve the same effect.

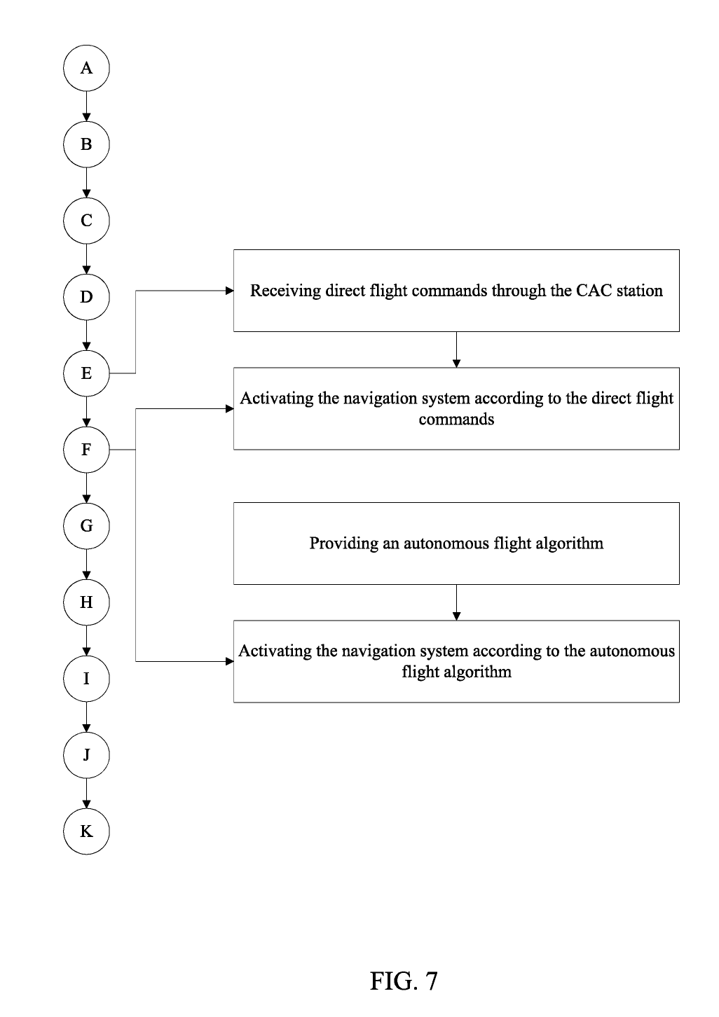

Referring to FIG. 7, in various embodiments, the present invention provides the ability to operate the UAV through either direct command or non-autonomous navigation, or autonomous navigation through internal flight algorithms. In one embodiment, direct flight commands are received through the CAC station, and the navigation system of the UAV is activated according to the direct flight commands. Thus, navigation of the UAV is directly controlled by a user through the CAC station. In another embodiment, an autonomous flight algorithm is provided, and the navigation system is activated according to the autonomous flight algorithm. The UAV may be able to switch between autonomous and non-autonomous flight, either by operator command through the CAC station or according to internal flight logic based on various factors.

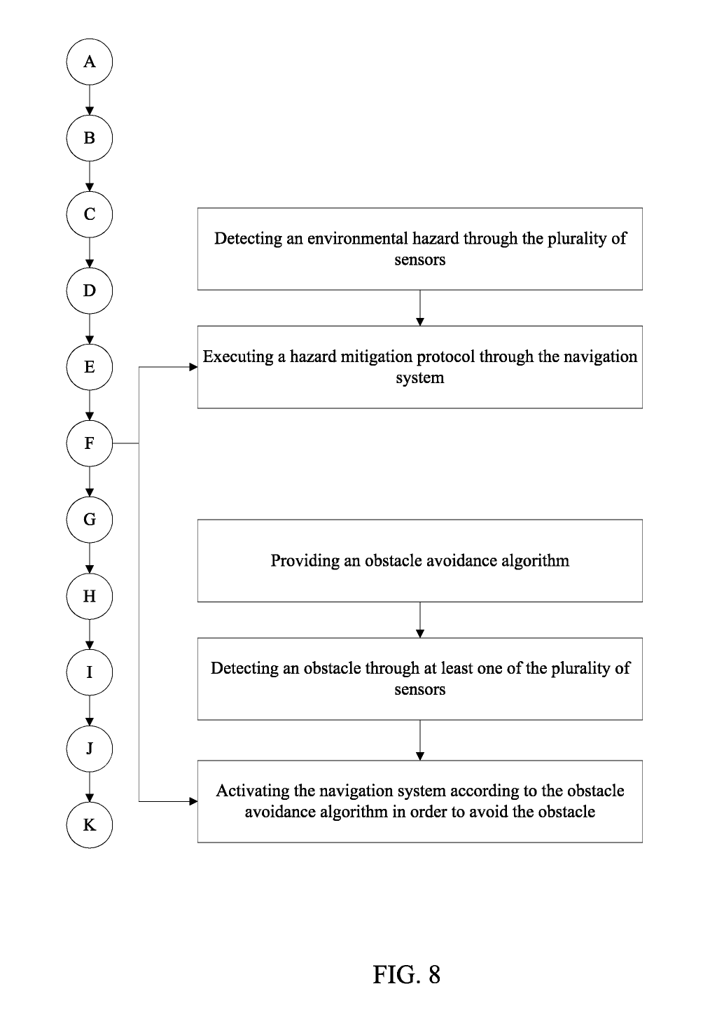

Referring to FIG. 8, One embodiment of the present invention also provides hazard detection and avoidance capability. Internal programming logic allows the detection of hazards through the plurality of sensors. If an environmental hazard is detected through the plurality of sensors, a hazard mitigation protocol is executed through the navigation system. Hazards that can be detected and avoided or mitigated may include explosions, radiation, acidic or caustic conditions, obstacles, or other hazards. The UAV is also able to avoid architecture, trees and other obstacles. An obstacle avoidance algorithm is provided in the internal programming logic. An obstacle may be detected through at least one of the plurality of sensors, such as, but not limited to, the optical sensor or sensors, radar, LIDAR, IR, sonar, laser rangefinder or other sensors. Once the obstacle is detected, the navigation system is activated according to the obstacle avoidance algorithm in order to avoid the obstacle.

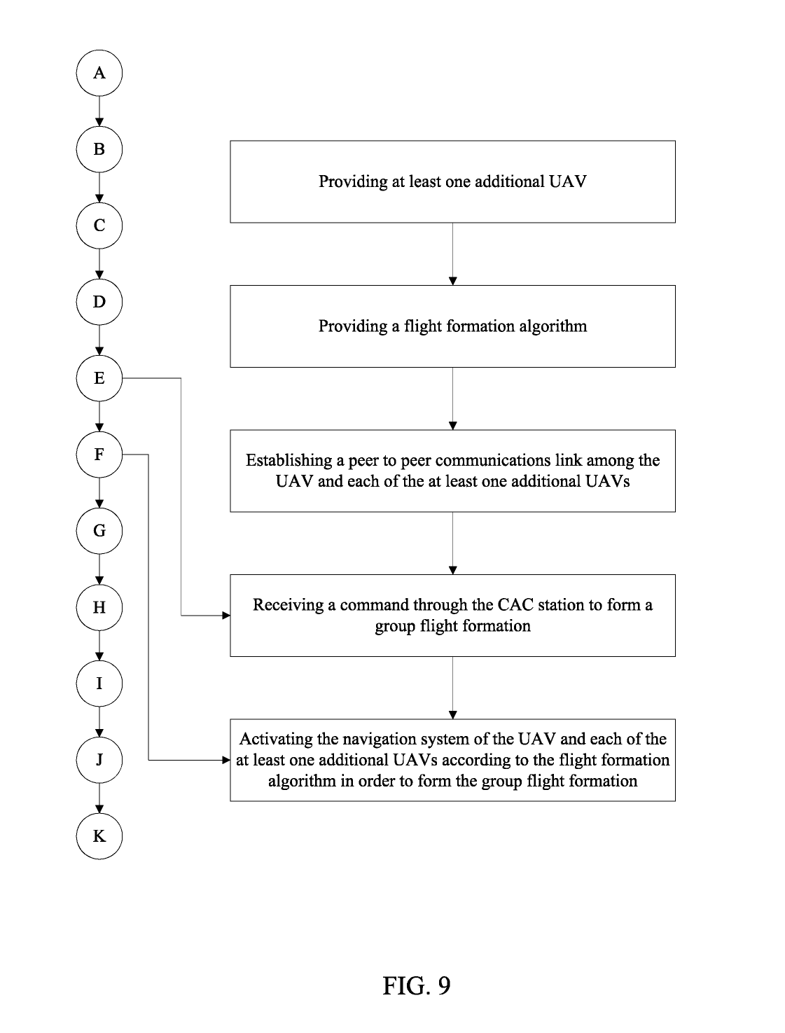

Referring to FIG. 9, another desired feature of the present invention is a swarm, or group flight, capability. Providing the UAV and at least one other additional UAV, along with a flight formation algorithm, a peer to peer communications link is established among the UAV and each of the at least one additional UAVs. Once a command is received through the CAC station to form a group flight formation, the navigation of the UAV and each of the at least one additional UAVs is activated according to the flight formation algorithm in order to form the group flight formation.

The following is a description of one exemplary embodiment of the present invention, and is not intended to be limiting. The following description is intended as illustrative of one potential example embodiment. The example embodiment hereinafter described is illustrative of a real-world implementation embodiment, and will hereinafter be referred to as the preferred embodiment.

The preferred embodiment encompasses a flight command and control module via the MISL controller, a high definition (HD) camera used for streaming HD quality pictures and video, autonomous and non-autonomous control logic for navigation, light detection and ranging (LIDAR) for mapping surroundings, hazardous and non-hazardous component protection, a set of sense and avoid features (proximity sensors and algorithms), light emitting diode (LED) interior and exterior lighting, and an encrypted set of cybersecurity technology attributes.

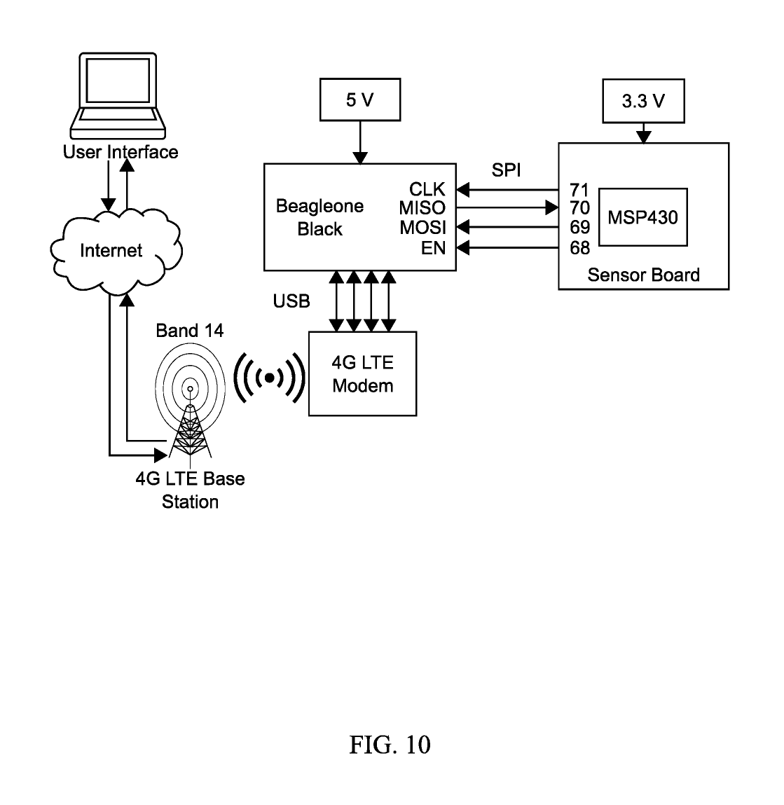

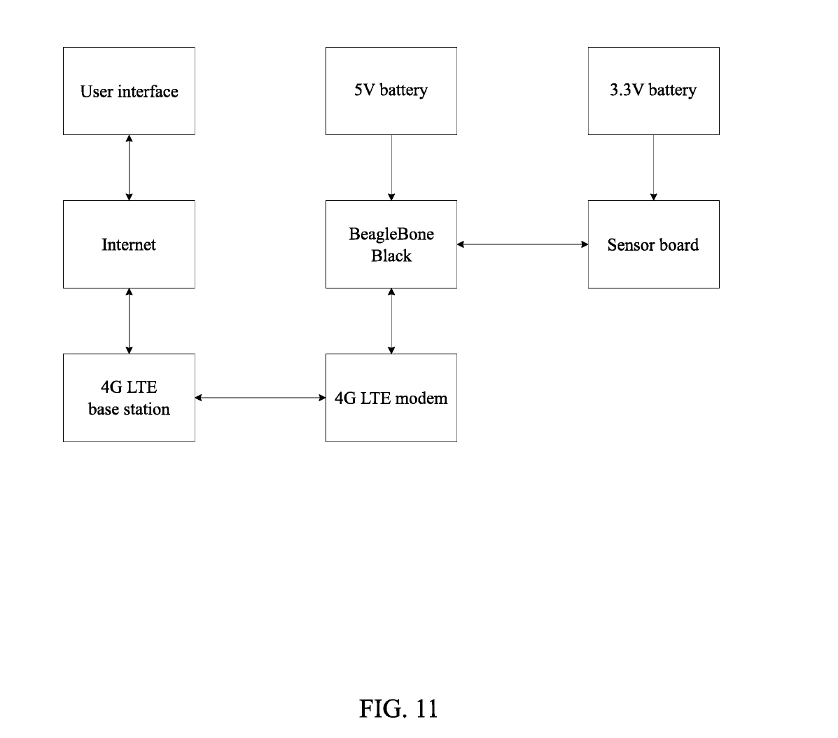

Referring to FIGS. 10 and 11, in the preferred embodiment of the present invention, the flight command and control will be performed (communicated) over a 4G LTE cellular network. This allows various unmanned aerial systems to utilize command and control plus communication technology, or C2+ technology which includes the public integrated network key infrastructure (PINKI) and modular integrated stackable layer (MISL). The public integrated network infrastructure details how the communication between the UAV and base station will be accomplished (preferred over 4G LTE, but can also communicate over WI-FI or networked with Bluetooth). The present invention utilizes a wireless 4G LTE chipset accessing the 4G LTE Public Safety Band 14 (700 MHz) network (i.e. 4G LTE Public Safety Band data link for control and video/data). The system will provide flight control in addition to a stream of both live video and flight data to the user over the 4G LTE Public Safety Band data link. The system has the capability to access the UAV flight controls, flight data, and video feed from a remote location by means of a C2+ Technology. The unmanned aerial vehicle will be equipped with an HD video device that can perform image capture in real time.

The MISL controller will provide a plug and play platform for easy onboarding of sensors and monitor packages. The MISL architecture comprises a series of layered printed circuit boards that can be quickly stacked into a small form factor footprint to provide a wide range of technology support for the preferred system. The MISL provides developers the ability to configure an application specific configuration by selecting from multiple options for power, microcontroller, communications, sensors and other signal conditioning circuitry. The MISL provides interoperability by means of the limitless plug and play sensor options. The MISL is an open system architecture with a host of drivers preloaded for environmental sensors, LED and infrared lighting, LIDAR scan and map, in addition to multiple commercial off the shelf (COTS) imagining components, such as GoPro, forward looking infrared (FLIR), and others. The MISL provides the option for full or non-autonomous modes by means of switching between external command and control, and internal flight algorithms. Depending on the sortie, the unmanned aerial vehicle can utilize the present inventions light detection and ranging technology to map surroundings and transition to full autonomous mode for activity execution such as surveillance, inspections, or enhanced remote sensing. The MISL also enables the ability to link with similarly equipped unmanned aerial systems and keep full spatial relationships (formation flying) in order to simulate and/or create a drone swarm capability. The MISL will be encrypted and encapsulated in order to provide secure communications. The wireless and Bluetooth capability of the MISL will include a Wireless N supporting 802.11n Wi-Fi wireless networking sensor and a BNEP/L2CAP protocols for sensor. The MISL will have a robust contingent management and health monitoring system. The MISL architecture, component selection, and physical arrangement will address features such as high reliability and quick deployment demands.

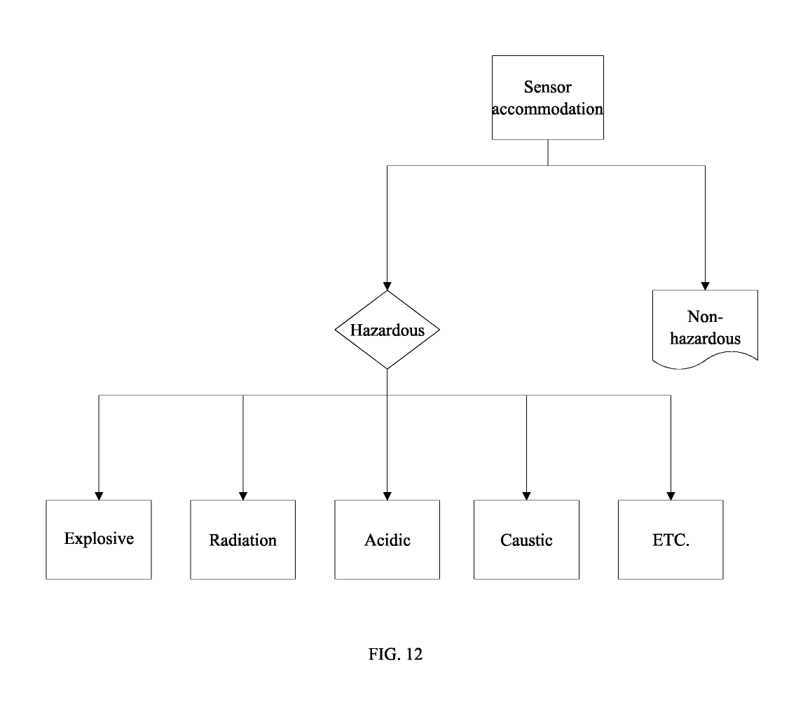

The current footprint of the present invention enhances various UAV embodiments by extending their ability to navigate through either enclosed internal areas or open exterior environments. The present invention augments UAV operations in the open air or inside enclosures with unknown internal configurations. Closed environments can include, but are not limited to: buildings, vessels, and pipes. The present invention will have hermetically sealed internal components in order to prevent outgassing or sparks which can lead to an explosion due to the presence of combustible gases. In addition, the circuit board will have a protective coating (conformal coatings) and features which can include, but is not limited to: radiation hardening and Magnetoresistive RAM (MRAM). Referring to FIG. 12, in addition, the present invention will include and utilize hazardous and non-hazardous environment material protection. Hazardous environments include can include environments that are explosive, radioactive, acidic, or caustic.

The present invention will include a set of sense and avoid features through the use of proximity sensors and associated algorithms. The sensors will be modular and/or interoperable and the sensors packages and algorithms are robust and can be customized in such a manner as to provide quicker response times to avoid oncoming unidentified bogeys, man-made or environmental hazards, terrestrial foliage, and other hazards.

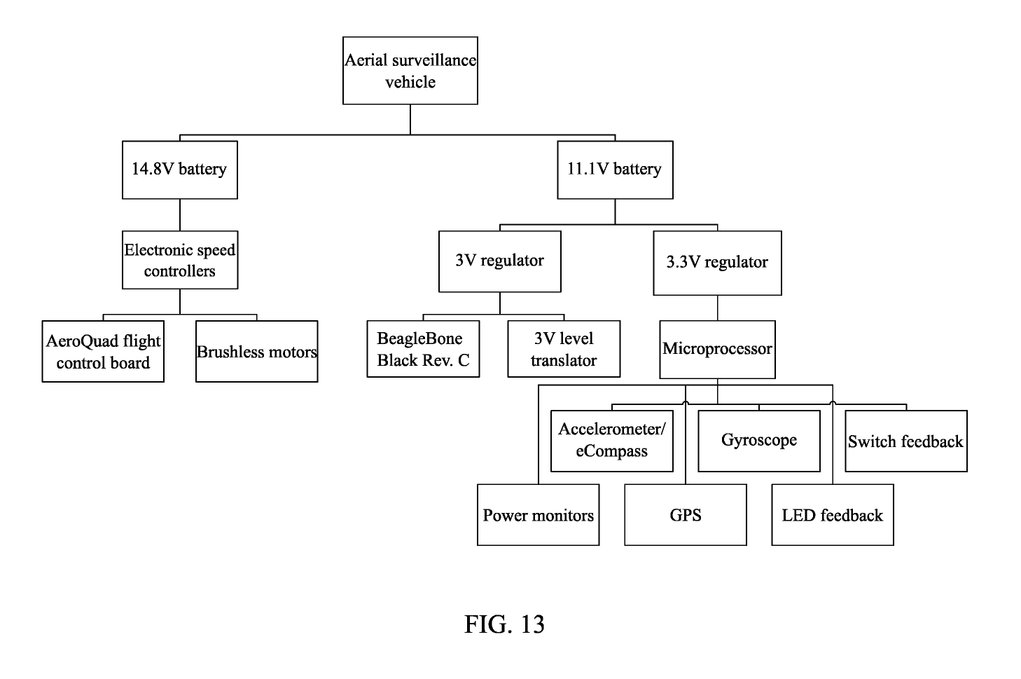

The preferred embodiment of the invention is a low form factor (dimensionally optimized), lightweight design. However, other embodiments use of the invention may increase the size, shape and weight of the invention as incorporated into the preferred embodiment with the ultimate goal of optimizing the systems overall portability. Referring to FIG. 13, the preferred embodiment of the invention includes a 14.8V battery and 11.1V battery. The 14.8V battery will connect to the electronic speed controller, which will control the AeroQuad flight control board and brushless motors. The 11.1V battery will include a 5V regulator and 3.3V regulator. The 5V regular will power a BeagleBone Black Rev. C and a 5V level translator. The 3.3V regulator will power a microprocessor. The microprocessor will control the power monitor sensors, accelerometer and eCompass, GPS, gyroscope, switch feedback, and LED feedback.

The power system includes a fuse used for overcurrent protection and a MOSFET for reverse polarity protection. There is a first switching regulator which regulates the 11.1V to 5V input, while there is a second switching regulator which regulates a 3.3V output. The 5V output provides power to the BeagleBone Black and several microprocessor support components.

The microprocessor, a Tiva TM4C123GH6PZI, is the main component of the sensor suite subsystem. The microprocessor is connected to sensors, headers, and support components, which include decoupling capacitors, I2C bus pullup resistors, expansion port, and the BeagleBone Black SPI connection. The microprocessor also connects to a MCU support, which further comprises of a camera gimbal controller, a microprocessor hardware reset switch, UAV flight control, JTAG interface, and clock crystals.

The power monitor sensors are used to measure the current supplied by the battery in order to determine how much charge remains. In the preferred embodiment of the invention, the power monitor sensors are based off the application circuits for current monitor sensors. The power monitor sensors will connect to the microprocessor through the I2C bus, I2C_01.

The accelerometer and eCompass used in the preferred embodiment of the invention is the LSM303D accelerometer/eCompass sensor and supporting components.

The accelerometer sensor will assist the unmanned aerial system maintain flight and remain stable. The sensor connects to the microprocessor through two GPIO pins. The sensor will connect to the microprocessor through the I2C bus, I2C_02.

The GPS sensor used in the preferred embodiment is the FGPMMOPA6H GPS sensor and supporting components. The support components will include a ferrite bead to attenuate high frequency noise on the power input, a pullup resistor for the GPS reset input, pullup resistors for the UART TX and RX lines, and a backup 3V battery in order to allow the GPS internal clock to continue running while powered off.

The gyroscope used in the preferred invention is the L3G4200D and its support components. The gyroscope also helps maintain the stability of the unmanned aerial vehicle. The gyroscope connects to the microprocessor through two GPIO pins and will be on the I2C bus, I2C_02.

The device includes LED internal and external lighting; internal primarily utilized for debugging purposes, and external for illumination. The internal LED lights will serve as outputs for the microprocessors miscellaneous functions. The internal LED lights will verify that the microprocessor is executing instructions correctly.

Although the invention has been explained in relation to its preferred embodiment, it is to be understood that many other possible modifications and variations can be made without departing from the spirit and scope of the invention as hereinafter claimed.

What is claimed is:

1. A system for controlling an unmanned aerial vehicle over a cellular network comprises:
an unmanned aerial vehicle (UAV);
a command and control (CAS) station;
the UAV comprises a navigation system, at least one processing unit, a plurality of sensors, at least one wireless communication device, and at least one power source;
the plurality of sensors comprises an optical sensor, an accelerometer, a compass sensor, a gyroscope sensor, and a global positioning system (GPS) sensor;
at least one of the processing units being electronically connected to the plurality of sensors;
at least one of the processing units being electronically connected to each wireless communication device;
at least one of the processing units being electronically connected to the navigation system;
at least one of the power sources being electrically connected to at least one of the processing units;
at least one of the power sources being electrically connected to the navigation system; and
the CAC station being communicatively coupled with at least one of the at least one processing units through a cellular network.

2. The system for controlling an unmanned aerial vehicle over a cellular network as claimed in claim 1 comprises:
the cellular network being a long-term evolution (LTE) network.

3. The system for controlling an unmanned aerial vehicle over a cellular network as claimed in claim 1 comprises:
the UAV further comprises a modular circuitry unit; and
the modular circuitry unit being electronically connected to each of the processing units, each of the plurality of sensors, and each wireless communication device.

4. The system for controlling an unmanned aerial vehicle over a cellular network as claimed in claim 3 comprises:
the modular circuitry unit being a modular integrated stackable layer (MISL) unit, wherein the MISL unit is configured for customization and combination of printed circuit boards.

5. The system for controlling an unmanned aerial vehicle over a cellular network as claimed in claim 1 comprises:
at least one of the processing units being communicatively coupled to the cellular network through one of the wireless communication devices.

6. The system for controlling an unmanned aerial vehicle over a cellular network as claimed in claim 1 comprises:
the at least one wireless communication device comprises a wireless networking transceiver complying with the Institute of Electrical and Electronics Engineers (IEEE) 802.11 wireless local area network (WLAN) standards.

7. The system for controlling an unmanned aerial vehicle over a cellular network as claimed in claim 1 comprises:
the at least one wireless communication device comprises a cellular network chipset; and
the at least one processing unit being communicatively coupled to the cellular network through the cellular network chipset.

8. The system for controlling an unmanned aerial vehicle over a cellular network as claimed in claim 7 comprises:
the cellular network chipset being a 4G LTE chipset.

9. The system for controlling an unmanned aerial vehicle over a cellular network as claimed in claim 1 comprises:
the optical sensor being mounted to a gimbal; and
the gimbal being electronically connected to the at least one processing unit, wherein the processing unit controls the gimbal.

10. The system for controlling an unmanned aerial vehicle over a cellular network as claimed in claim 1 comprises:
each processing unit, the plurality of sensors, each wireless communication device, and each power source being hermetically sealed.

11. A method of operating a system for controlling an unmanned aerial vehicle over a cellular network by executing computer-executable instructions stored on a non-transitory computer-readable medium comprises the steps of:
providing an unmanned aerial vehicle (UAV), a CAC station, and a cellular network, wherein the UAV comprises a plurality of sensors, a modular circuitry unit, and a navigation system, and wherein the plurality of sensors comprises an optical sensor and a plurality of navigation sensors;
providing at least one circuitry component, wherein each of the at least one circuitry component is configured to execute an operational algorithm for a specific operational capability;
establishing a local communications link between the modular circuitry unit and the at least one circuitry component;
establishing a remote communications link between the UAV and the CAC station through the cellular network;
receiving navigation input through the CAC station;
activating the navigation system according to the navigation input;
continually recording visual data through the optical sensor;
continually transmitting the visual data through the remote communications link to the CAC station;
continually recording flight data through the plurality of navigation sensors;
transmitting the flight data through the remote communications link to the CAC station; and
executing the operational algorithm for a selected circuitry component from the at least one circuitry component, if a prerequisite condition for the operational algorithm of the selected circuitry component is met.

12. A method of operating a system for controlling an unmanned aerial vehicle over a cellular network by executing computer-executable instructions stored on a non-transitory computer-readable medium as claimed in claim 11 comprises the steps of:
providing the prerequisite condition as detection of a specified condition; and
executing the operational algorithm of the selected circuitry component, if the specified condition is detected.

13. A method of operating a system for controlling an unmanned aerial vehicle over a cellular network by executing computer-executable instructions stored on a non-transitory computer-readable medium as claimed in claim 11 comprises the steps of:
providing the prerequisite condition as the local communications link being established; and
executing the operational algorithm of the selected circuitry component while the local communications link is established.

14. A method of operating a system for controlling an unmanned aerial vehicle over a cellular network by executing computer-executable instructions stored on a non-transitory computer-readable medium as claimed in claim 11 comprises the steps of:
receiving direct flight commands through the CAC station; and
activating the navigation system according to the direct flight commands.

15. A method of operating a system for controlling an unmanned aerial vehicle over a cellular network by executing computer-executable instructions stored on a non-transitory computer-readable medium as claimed in claim 11 comprises the steps of:
providing an autonomous flight algorithm; and
activating the navigation system according to the autonomous flight algorithm.

16. A method of operating a system for controlling an unmanned aerial vehicle over a cellular network by executing computer-executable instructions stored on a non-transitory computer-readable medium as claimed in claim 11 comprises the steps of:
detecting an environmental hazard through the plurality of sensors; and
executing a hazard mitigation protocol through the navigation system.

17. A method of operating a system for controlling an unmanned aerial vehicle over a cellular network by executing computer-executable instructions stored on a non-transitory computer-readable medium as claimed in claim 11 comprises the steps of:
providing an obstacle avoidance algorithm;
detecting an obstacle through at least one of the plurality of sensors; and
activating the navigation system according to the obstacle avoidance algorithm in order to avoid the obstacle.

18. A method of operating a system for controlling an unmanned aerial vehicle over a cellular network by executing computer-executable instructions stored on a non-transitory computer-readable medium as claimed in claim 11 comprises the steps of:
providing at least one additional UAV;
providing a flight formation algorithm;
establishing a peer to peer communications link among the UAV and each of the at least one additional UAVs;
receiving a command through the CAC station to form a group flight formation; and
activating the navigation system of the UAV and each of the at least one additional UAVs according to the flight formation algorithm in order to form the group flight formation.
